(19) United States
(12) Patent Application Publication
(10) Pub. No.: US 2004/0109921 A1
(43) Pub. Date: Jun. 10, 2004

(54) Ice cream cone with fortune

(76) Inventor: Alexis Diaz, Aspen, CO (US)

Correspondence Address: HOLLAND & HART, LLP, 555 17TH STREET, SUITE 3200, DENVER, CO, 80201, US

(21) Appl. No.: 10/315,592

(22) Filed: Dec. 10, 2002

(51) Int. Cl. A23L 1/00

(52) U.S. Cl. 426/87

(57) ABSTRACT

The present invention provides a edible, frozen confectionary holder having a primary chamber for holing the confectionary. Attached to the primary chamber is a fortune that can be stamped on the primary chamber sidewalls or contained on a media residing in a secondary chamber.

### BACKGROUND OF THE INVENTION

Traditional ice cream cones, and the methods and apparatus for making such cones, are well known in the prior art. There are a variety of edible, hand held containers or cones capable of holding ice cream or other frozen confections, such as yogurt: wafer or cake cones and sugar or waffle cones. Wafer or cake cones are baked in molds using what is generally referred to in the art as a “liquid” dough generally composed of water, flour and sugar, wherein the sugar content of the dough is relatively low, 6 or 7% by weight. Wafer or cake cones are generally 1/32″ to 1/16″ thick and are baked between 1 to 1½ minutes. Sugar or waffle cones, on the other hand, are baked flat and then rolled into a cone shape using dough having relatively high sugar content, 25% or more by weight. U.S. Pat. No. 3,541,587 describes a sugar cone having 15% sugar by weight and at least 0.5% by weight of a starch that prevents sticking so the sugar cone can be made using molds like a wafer or cake cone.

While one of the primary functions of an ice cream cone is to hold the ice cream or other frozen confection, the cone itself is also to be consumed. Various methods and products have been created to enhance the enjoyment of eating an ice cream cone by making changes to the flavor and taste of the cones. For example, U.S. Pat. No. 4,104,405 describes a cone having an expanded confection ring around the top of the cone, U.S. Pat. No. 5,064,666 describes an apparatus for coating the interior of the cone with a chocolate layer, and U.S. Pat. No. 4,600,591 describes a cone comprised of a pair of concentric tapped wafer cones having a layer of cream interposed between the two wafer cones.

The fortune cookie is another fun, edible product generally known in the United States. Fortune cookies were invented in San Francisco in the last century. They had their paper slip “fortunes” inserted by hand and were laboriously formed by hand labor into the familiar fortune cookie shape. In about 1963, the first practical apparatus for automatically inserting paper fortunes into fortune cookies and automatically forming them into the fortune cookie shape was introduced by Yau Tak Cheung. U.S. Pat. No. 3,265,016, entitled Fortune Cooky Machine was awarded to Mr. Cheung for this invention on Aug. 9, 1966. Since then a number of improvements and alternative apparatuses have been patented, notably U.S. Pat. No. 3,605,642 to R. E. Brown, Fortune Cookie Machine, issued Sep. 20, 1971, U.S. Pat. No. 3,950,123 to E. Louie, Apparatus for Making a Food Product, issued Apr. 13, 1976; and U.S. Pat. No. 3,983,262 to R. H. M. Brunner, et al., Automatic Fortune Cookie Folding Method.

Based on the forgoing, it would be desirous to increase the enjoyment of eating frozen confectionary, such as ice cream, by adding a fortune similar to a fortune cookie.

### SUMMARY OF THE INVENTION

The advantages and purpose of this invention will be set forth in part from the description, or may be learned by practice of the invention. The advantages and purpose of the invention will be realized and attained by means of the elements and combinations particularly pointed out in the appended claims.

To attain the advantages and in accordance with the purpose of the invention, as embodied and broadly described herein, apparatus consistent with the present invention include a container having a primary and secondary chamber. The primary and secondary chamber a separated by a dividing wall. The secondary chamber contains a medium having an alpha, numeric, graphic, or other depiction.

### BRIEF DESCRIPTION OF THE DRAWINGS

The accompanying drawings, which are incorporated in and constitute a part of this specification, illustrate preferred embodiments of the invention and, together with the description, explain the goals, advantages and principles of the invention. In the drawings:

FIG. 1 is a perspective view of an ice cream cone illustrative of the present invention.

### DETAILED DESCRIPTION

Reference will now be made in detail to an embodiment of the present invention, an example of which is illustrated in the accompanying drawing. It is intended that all matter contained in the description below or shown in the accompanying drawings shall be interpreted as illustrative and not in a limiting sense.

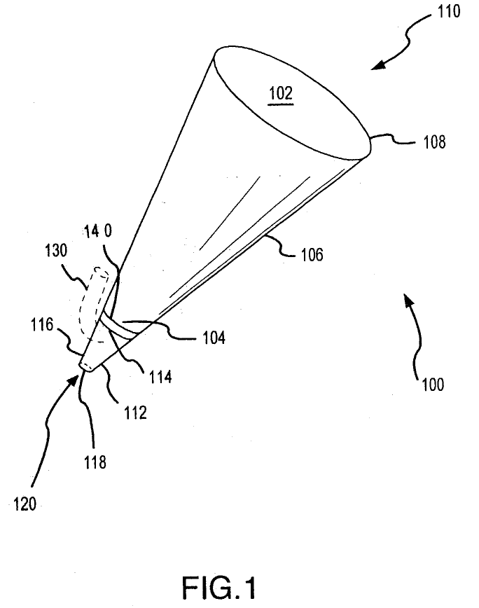

Referring now to FIG. 1, an ice cream cone 100 is shown. Ice cream cone 100 comprises a primary chamber 102 having a bottom surface 104, primary sidewalls 106, and a top edge 108 defining a primary opening 110. Ice cream cone 100 further comprises a secondary chamber 112 having a top surface 114, secondary sidewalls 116, a bottom edge 118 defining a secondary opening 120. While primary chamber 102 is shown as a generally conical shape, alternative configurations are possible, such as, for example, cylindrical, square, circular or cup shape, or the like. Also, secondary chamber is shown as a flat cylindrical shape (or an envelope shape with a open end), alternative configurations are possible, such as, for example, a bubble, circular, square, triangular, conical shape, or the like. Further, top edge 108 and primary opening 110 are optional, and ice cream cone 100 could have an enclosed primary chamber as a matter of design choice. Similarly, bottom edge 118 and secondary opening 120 are optional also.

Primary chamber 102 would contain a frozen confectionary, which will be generically referred to as ice cream, as a traditional ice cream cone. Secondary chamber 112 would contain a media (not shown), such as paper, with a depiction, such as a graphic, numeric, alpha, or alphanumeric writing, generically referred to as a fortune, similar to a traditional fortune cookie. Separating the primary chamber 102 and the secondary chamber 112 is a dividing wall 120. Dividing wall 140 inhibits the ice cream in primary chamber 102 from melting into secondary chamber 112, which could damage the media. As can be appreciated, dividing wall 140 comprises the bottom surface 104 of the primary chamber 102 and the top surface 114 of the secondary chamber 112.

While primary chamber 102 and secondary chamber 112 are shown as shapes extending in alternate directions, alternative placement of secondary chamber 112 is possible. For example, a traditional ice cream cone could be used with a secondary chamber existing off one of the sidewalls, comparable to a bubble. Still alternatively, the secondary chamber could extend in the primary chamber. Still another embodiment could be a primary chamber having a flat bottom, such as a wafer cone, with a secondary chamber formed beneath the flat bottom. Yet anther embodiment of the present invention could have the primary chamber 102 with a secondary chamber 130 (shown in phantom on FIG. 1) wrapped upwards along or around (not shown) primary chamber 102 (a.k.a., the traditional cone shape). Thus, instead of the dividing wall, a bend in the cone would form leak accompanied by a pinching of the sidewalls will form a leak inhibiting point to inhibit leakage. Another way of making the present invention has a cone or cookie in the shape of a circle. While the cookie is still hot and pliable, the cookie is rolled around a wooden cone roller, leaving extra at the base of the cone. Before the cone is completely rolled up, a fortune is tucked in the excess on the bottom, and the excess is folded up towards the top of the cone. Then the cone is finished. These examples are provided for illustration and should be considered non-limiting.

To provide the appearance of the traditional fortune cookie, secondary chamber 112 may be curved. Further, a portion of the media may reside outside secondary chamber 112 through secondary opening 120. Alternatively, secondary chamber 112 could be sealed off with the media fully contained within the chamber. Of course, stamping or baking the fortune to a portion of the traditional ice cream cone, which would be placing the fortune on placing sidewall 106 of primary chamber 102, also could accomplish the ice cream cone with fortune. In this case, secondary chamber 112 could be eliminated from the cone. However, it is believed a consumer would find this option less desirable.

As one of skill in the art would recognize on reading the disclosure above, the present invention could be a modification to traditional ice cream cones, such as sugar cones, waffle cones, wafer cones, or the like. Alternatively, the cone could be formed out of traditional fortune cookie ingredients, which it is believed would make a sturdier cone more susceptible to manipulation of a secondary chamber and would make the ice cream cone more reminiscent of the traditional fortune cookie. Many other types of cake and cookie dough ingredients as are known in the art are also possible.

Although the description of some embodiments of the present invention has been presented, it is contemplated that various changes could be made without deviating from the spirit of the present invention. Accordingly, it is intended that the scope of the present invention be dictated by the appended claims rather than by the description of the embodiments.

I CLAIM:

1. An edible, frozen confectionary container, comprising:
a primary chamber;
a secondary chamber;
a dividing wall;
the dividing wall having a primary surface and a secondary surface;
the primary chamber defined by a primary sidewall and the primary surface, the secondary chamber defined by a secondary sidewall and the secondary surface, wherein
the secondary chamber is adapted to contain a media.

2. The container of claim 1, wherein the primary chamber is designed to primarily contain at least one of ice cream and yogurt.

3. The container of claim 1, wherein the secondary chamber contains at least one media.

4. The container of claim 3, wherein the at least one media comprises paper having at least one depiction.

5. The container of claim 4, wherein the at least one depiction comprises at least one of a graphic depiction, an alpha depiction, a numeric depiction, and an alphanumeric depiction.

6. The container of claim 1, wherein the primary chamber is made out of at least one of a waffle batter, a sugar batter, a wafer batter, a fortune cookie batter, a cake batter, and a cookie dough batter.

7. The container of claim 1, wherein the secondary chamber is made out of at least one of a waffle batter, a sugar batter, a wafer batter, a fortune cookie batter, a cake batter, and a cookie dough batter

8. The container of claim 6, wherein the secondary chamber is made out of at least one of a waffle batter, a sugar batter, a wafer batter, a fortune cookie batter, a cake batter, and a cookie dough batter.

9. The container of claim 8, wherein the secondary chamber is made out of a different material than the primary chamber.

10. An edible, frozen confectionary container, comprising:
means for containing a confectionary; and
means for providing a fortune connected to the means for containing.

11. The container of claim 10, wherein the means for containing the confectionary includes a primary chamber defined by sidewalls, a bottom surface, and an upper edge, the upper edge defines a primary opening.

12. The container of claim 10, wherein the means for providing a fortune comprises:
placing a fortune on the primary chamber.

13. The container of claim 10, wherein the means for providing a fortune comprises:
a secondary chamber adapted to contain a media.

14. The container of claim 13, wherein the secondary chamber is defined by secondary sidewalls and a top surface, the top surface being generally opposed the bottom surface.

15. The container of claim 14, wherein the secondary chamber is further defined by a secondary edge defining a secondary opening, the secondary opening being adapted to allow a portion of the media to reside outside the secondary chamber.

16. The container of claim 13, wherein the secondary chamber is connected to the primary chamber by a bend, such that the secondary chamber extends at least one of perpendicular or parallel to the primary chamber.

17. The container of claim 16, wherein the bend is pinched.

18. The container of claim 13, wherein the secondary chamber extends from the sidewalls external to the primary chamber.

19. The container of claim 13, wherein the secondary chamber extends from the sidewalls internal to the primary chamber.

20. The container of claim 10, wherein the means for containing the confectionary is made out of at least one of a waffle batter, a sugar batter, a wafer batter, a fortune cookie batter, a cake batter, and a cookie dough batter.
